(19) United States
(12) Patent Application Publication
(10) Pub. No.: US 2002/0023056 A1
(43) Pub. Date: Feb. 21, 2002

(54) System and method for creation of backed depositary receipts

(76) Inventors: Augustine F. Udo, New York, NY (US); Edward Tittmann, New York, NY (US)

Correspondence Address: DARBY & DARBY P.C., 805 Third Avenue, New York, NY, 10022, US

(21) Appl. No.: 09/931,152

(22) Filed: Aug. 16, 2001

Related U.S. Application Data
(60) Provisional application No. 60/225,957, filed on Aug. 17, 2000.

(51) Int. Cl. G06F 17/60

(52) U.S. Cl. 705/40; 705/36

(57) ABSTRACT

A method for creating backed derivatives includes the steps of depositing a collateral in a clearinghouse firm, electronically advising a custodian firm of the deposit, monitoring in real-time for the continued presence of the collateral in the clearinghouse firm, and authorizing a depository firm to issue a set of derivatives if the continued presence of the collateral is confirmed. Also disclosed is a method for ensuring that an issuer continues to possess a payable instrument in which a communication link is established between a custodian firm of the issuer and a clearinghouse firm, the clearinghouse firm is polled as to whether the issuer possesses the payable instrument in a custodial account of the issuer, an electronic confirmation is transferred to the custodian firm confirming the presence of the payable instrument in the custodial account, and in which these steps are repeated throughout the trading day.

This application claims the benefit of priority under 35 U.S.C. §119(e) of U.S. Provisional Application Serial No. 60/225,957, filed Aug. 17, 2000, entitled “System and Method for Creation of Backed Depositary Receipts,” which is hereby incorporated by reference in its entirety.

### FIELD OF THE INVENTION

The present invention relates to the unbundling of payable instruments, such as bonds or invoices, into strips or a series of smaller denominations than the original face value on the payable instrument and to the transformation of payment claims into a more easily tradeable format (e.g., a digital receipt or some other series of securities). More particularly, the invention relates to a system and method for ensuring that an issuer possesses a payable instrument and therefore has the authority to issue receipts with respect to that instrument.

### DESCRIPTION OF RELATED ART

A payable instrument is a bond, invoice or any other document (paper or electronic) which requires payment of a specified value. The terms “payable instrument”, “collateral” and “asset” are used interchangeably, and are sometimes referred to as the asset backing. Payable instruments maybe unbundled into depositary receipts (“strips”) or some other series of securities for further negotiation or transformed into more easily tradeable digital securities. For example, depositary receipts unbundled from a payable instrument are sometimes referred to as “asset backed securities.” Customers, e.g., individuals or financial institutions, willing to purchase depositary receipts of the payable instrument from an issuer, e.g., a financial institution, are at risk that the issuer may be selling more receipts than are in their possession or a larger accumulated denomination than the original face value on the instrument. Clearinghouse firms, such as Euroclear or Clearstream, confirm receipt of payment instruments as collateral for receipts issued against that instrument. However, no real-time control exists for a customer to ensure that an issuer retains possession of a payable instrument from which receipts have been issued.

Conventionally, an issuer, such as a bank or other financial institution, issues depositary receipts (e.g. strips) through a clearinghouse firm or its designated agent, whereupon any consumer, such as another financial institution or an individual, can purchase the issued receipts from the issuer. However, the transaction proceeds, in part, on faith because there is no control in place to continuously verify that the issuer has the collateral to back the receipt being issued to the consumer. Rather, daily reports confirm coincidence of collateral and issued receipts, but there is room in the present methodology for gamesmanship throughout the day, so long as at the time a report is generated the assets deposited with the clearinghouse firm match the depositary receipts being issued. Consequently, consumers are willing to purchase depositary receipts from only the largest and most trusted issuers.

It is therefore desirable to develop a system and method by which the consumer can confirm on a continuous real-time basis that the issued depositary receipts are backed by sufficient collateral.

### SUMMARY OF THE INVENTION

In accordance with one aspect of the invention, a method for creating backed derivatives includes the steps of depositing a collateral in a clearinghouse firm, electronically advising a custodian firm of the deposit, monitoring in real-time for the continued presence of the collateral in the clearinghouse firm, and authorizing a depository firm to issue a set of derivatives if the continued presence of the collateral is confirmed.

In accordance with a related aspect of the invention, a method for the creation of backed derivatives includes the steps of depositing a collateral having a first value in a clearinghouse firm, electronically advising a custodian firm of the deposit, preparing a set of derivatives to be issued, the set of derivatives having a second value that matches the first value, monitoring in real-time for the continued presence of the collateral in the clearinghouse firm, and authorizing a depository firm to issue the set of derivatives if the continued presence of the collateral is confirmed.

In accordance with another aspect of the invention, a method for ensuring that an issuer continues to possess a payable instrument includes the steps of establishing a communication link between a custodian firm of the issuer and a clearinghouse firm, the clearinghouse firm having a custodial account for the issuer; polling the clearinghouse firm through the communication link as to whether the issuer possesses the payable instrument in the custodial account; transferring an electronic confirmation from the clearinghouse firm to the custodian firm across the communication link, the electronic confirmation confirming the presence of the payable instrument in the custodial account of the issuer; and repeating steps (a) through (c) throughout the trading day.

More generally, methods are provided for ensuring that depositary receipts are adequately backed by sufficient collateral to enable, among other things, small and less known financial institutions to be issuers of receipts. The invention provides digital electronic confirmations of receipt and continued possession of the collateral that underlies a depositary receipt thereby enabling potentially any financial institution to serve as an issuer due to the trustworthiness imparted to such issuers as a result of continuous real-time monitoring of the presence of such collateral. Commissions can be garnered for management and monitoring of each payable instrument.

Other aspects, features and advantages of the invention can be appreciated from the drawing figures and description of a preferred embodiment of the invention.

### BRIEF DESCRIPTION OF THE DRAWING FIGURES

FIG. 1 is an exemplary high-level diagram of the system in accordance with a preferred embodiment of the present invention;

FIG. 2 is a flow diagram of the operation of the system in accordance with the preferred embodiment;

FIG. 3 is a flow diagram of an auction process in accordance with the preferred embodiment; and

FIG. 4 is a flow diagram of the computation of a price for a security in accordance with the preferred embodiment.

### DETAILED DESCRIPTION OF THE PREFERRED EMBODIMENT

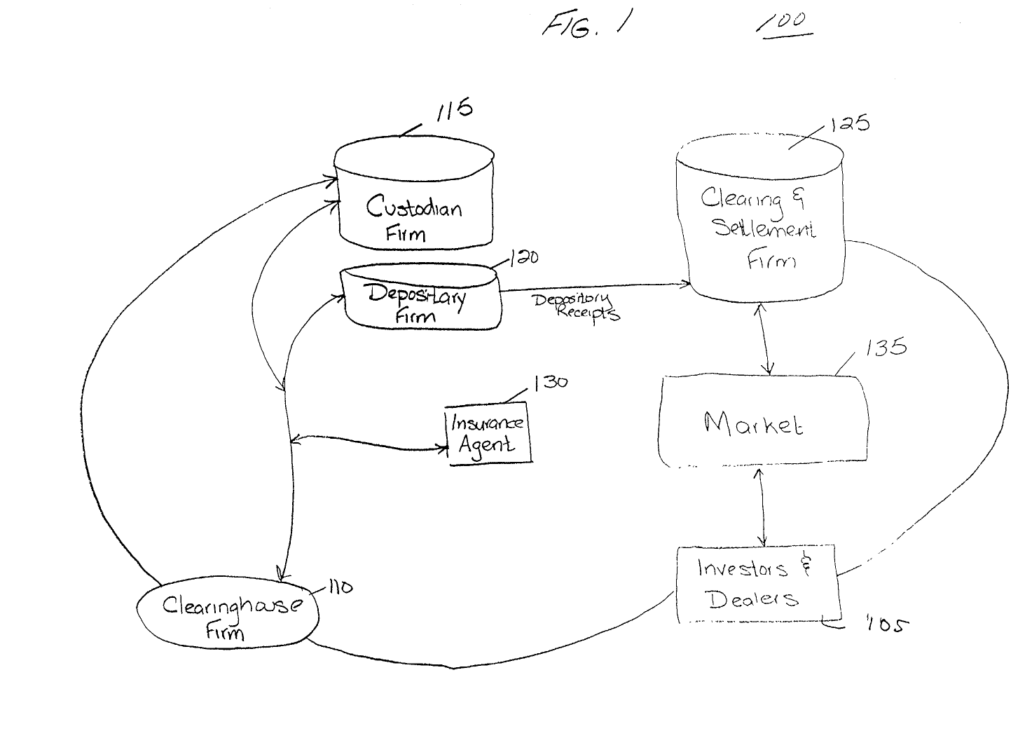

FIG. 1 is an exemplary diagram of the system 100 in accordance with the present invention. A custodian firm 115 establishes a custody account with a clearinghouse firm 110, while a depository firm 120 establishes a depositary account with the custodian firm. Although FIG. 1 shows the custodian firm and depository firm as two separate firms, in an alternative embodiment these two firms maybe merged into a single firm performing the same functionality. An investor 105 delivers a payable instrument free and clear to the custody account with the clearinghouse firm 110. Upon deposit of the payable instrument, the clearinghouse firm 110 sends a signal to the custodian firm 115 of its receipt of the payable instrument. Custodian firm 115, in turn, notifies the depository firm 120 of receipt of the payable instrument at the clearinghouse firm 110. From the time of notification of receipt of depositary of the payable instrument in the clearinghouse firm 110, the custodian firm 115 continuously polls the clearinghouse firm 110 on a real-time basis to confirm that the specified value of the assets in the custody account matches the depositary receipts (e.g., strips) being issued by the depository firm 120. That is, the custodian firm continuously monitors on a real-time basis to ensure that the amount of depositary receipts being issued by the depository firm 120 matches the amount of assets held in the custody account. Specifically, the custodian firm transmits a polling signal to the clearinghouse firm 110 which, in turn, transmits back to the custodian firm a signal representing the current amount of assets held in the custody account at the clearinghouse firm 110. The custodian firm confirms that the aggregate value of the intended depositary receipts to be issued by the depository firm 120 matches the value of the assets in the custody account with the clearinghouse 100.

If the custodian firm 115 confirms that the aggregate value of the intended depositary receipts to be issued by the depository firm 120 matches the value of the assets in the custody account at the clearinghouse, then the custodian firm sends a signal to the depository firm 120 authorizing generation and issuance of the depositary receipts. Preferably the depositary receipts are in electronic form, however, paper receipts alternatively may be used. Each depositary receipt is assigned a security identifier, for example, a CUSIP number, using conventional codes known to one of ordinary skill in the art. The issued depositary receipts from the depository firm 120 may be received in respective customer accounts at a clearing and settlement firm 125. Customers are able to enter into market trading (see arrows leading to box 135) of the issued electronic depositary receipts deposited in their customer accounts at the clearing and settlement firm 125.

Not only is the custodian firm 115 able to continuously monitor or poll the value of the assets in the custody account at the clearinghouse 100, other third parties who potentially would be harmed should the investor not have possession of the payable instrument may also have access to such information. For example, an insurance company or agent that guarantees the assets of a payable instrument may monitor the value of the assets in the custody account. Similarly, the customer who purchases a receipt may confirm the amount of the underlying assets in the depositary's custody account even after the purchase is completed.

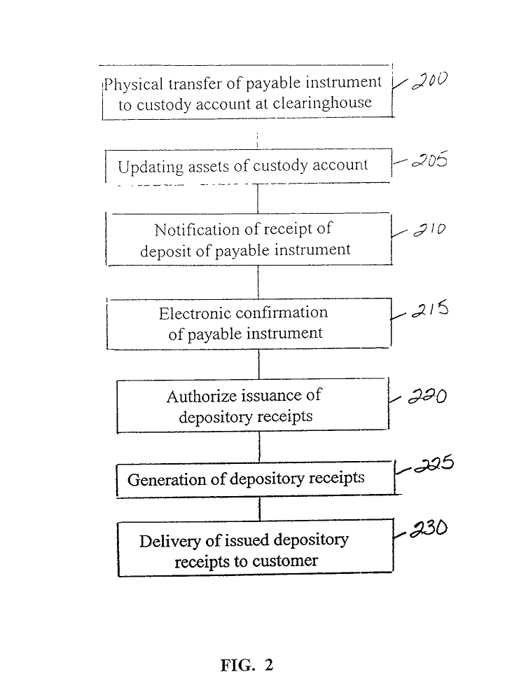

FIG. 2 is a flow diagram of the operation of the system in accordance with the present invention. Initially, in step 200 the investor physically or electronically transfers the payable instrument (collateral) to the custodian's account in the clearinghouse 110. If additional assets are being deposited in the custody account, then the aggregate value of the assets in the account is updated in step 205. A signal is generated by the clearinghouse firm 110 and transmitted to the custodian firm 115 of notification of receipt of deposit of the payable instrument in the custody account with the clearinghouse firm. Thereafter, in step 215 the custodian firm 115 and/or depository firm 120 continuously poll on a real-time basis the clearinghouse firm 110 to confirm that the payable instrument is still being held by the clearinghouse firm 110. If the custodian firm receives confirmation from the clearinghouse confirming the payable instrument is in the custody account, then in step 220 a signal is generated by the custodian firm 115 and transmitted to the depository firm 120 authorizing issuance of the depositary receipts. In steps 225-230, the depository firm 120 generates electronic depositary receipts which are delivered directly to the customer or deposited in a customer's account within the clearing and settlement firm 125. The electronic depositary receipts themselves maybe traded in the market 135. After the payable instrument has been physically or electronically deposited in the clearinghouse firm 110 and even after the depositary receipts have been issued and delivered to the customer, the clearinghouse firm is continuously polled on a real-time basis to confirm that the depositary receipts are fully backed by the payable instrument.

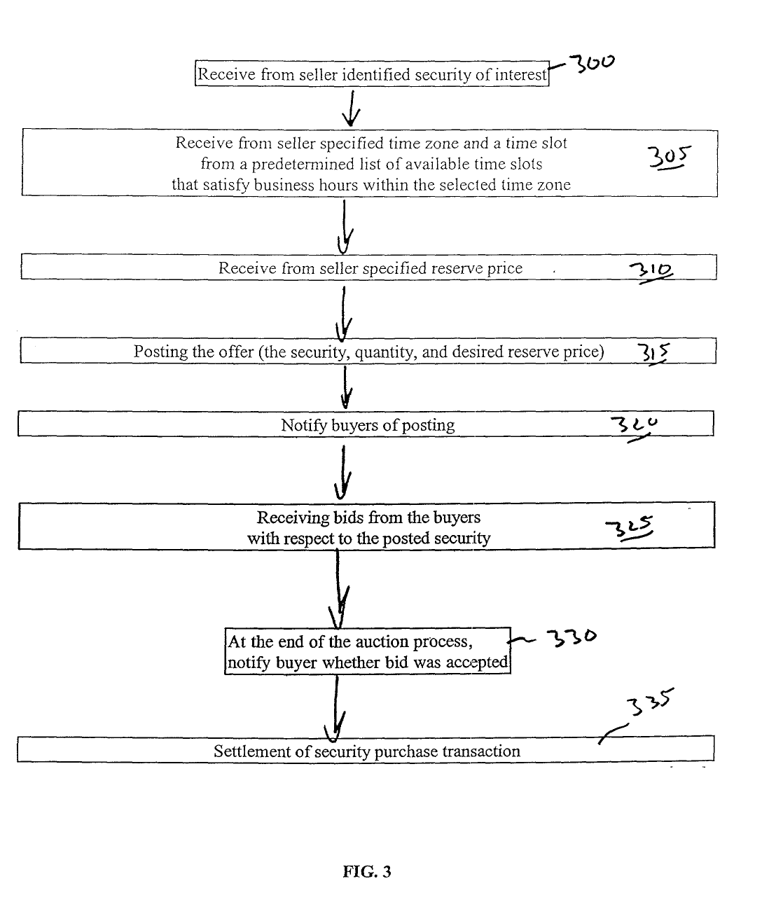

The depositary receipts deposited in the clearing and settlement firm 125 may be electronically traded in an auction format by visiting a Web site. Trading is preferably structured as a forward inquiry auction wherein the seller is the one to identify a particular security of interest and a reserve price. FIG. 3 is an exemplary flow diagram of the auction process. In step 300, a seller interested in selling a security accesses a Web site and identifies a particular security of interest. For example, the seller may select from an existing electronic database of what the seller owns, or select from among a predetermined list of common and/or previously identified securities, or enter the data directly (in which case data is electronically matched to a database maintained by the Web site).

Once a particular security of interest has been selected, in step 305 the interested seller first selects one or more time zones and then specifies a time slot at which to bid at auction from a predetermined list of available time slots that satisfy business hours within the selected time zones. In addition to selecting a particular security and a time slot, the seller also specifies a reserve price in step 310.

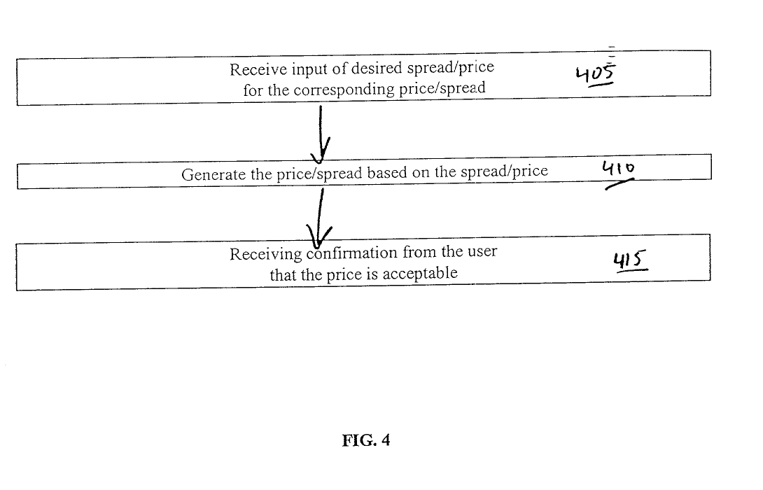

FIG. 4 is a flow chart of the operational processing performed in determining a desired reserved price and likewise for proposing a desired bid using a price calculator in accordance with the present invention. In a preferred embodiment, the auction is a price auction rather than a spread auction. In a price auction, the highest bid price wins, whereas in a spread auction the spread can stay the same but the price of the asset can change if the benchmark fluctuates during the auction. The winner in a spread auction has the lowest spread, wherein the benchmark is the price of the security at the end of the auction. In either type of auction, either a price or a spread is specified by the user in units of the user's choice, that is, a spread or price, with the calculations performing the necessary transformation in accordance with prescribed formulas.

The system in response to the user selecting a particular security and an associated auction slot generates a Web page displaying the price calculator with the information concerning the selected security automatically pre-filled with the relevant data. The relevant data for the calculator to determine a price or spread of a particular security includes, in the case of a fixed rate instrument: the coupon rate, the coupon type, the maturity, the payment frequency, and the benchmark security off of which the spread is based. The benchmark security is typically a U.S. Treasury bond, the price of which the system receives in real-time from GovPX, a company dedicated to providing the industry with live prices of various interest rate instruments. The calculator itself incorporates industry standard and accepted formulas provided by Tips Inc. of Summit, N.J. In the case of a floating rate instrument, the same data as described above is relevant, however, a further calculation, using a series of live feeds from GovPX, is needed in order to calculate the expected future cash flows of the instrument.

In step 405 the system receives the user's input of a desired spread for a corresponding price or equivalently a desired price for a corresponding spread, in the appropriate data entry field of the calculator. The system, in response to the user clicking on a calculate button or icon, generates a price(spread) based on the spread(price) in step 410 using the prescribed formula. In response to the user posting the resulting bid or offer, in step 415 the generated price/spread is automatically input into a data entry field. To ensure that the price is acceptable, the system preferably waits for confirmation from the user. Instead of using the calculator, the user may enter his or her own price or spread entry. In addition to specifying the price/spread, the user is also prompted to input the quantity of securities to be purchased, unless the lot is designated as “All-or-None,” wherein the quantity can be automatically generated, e.g., from the electronic database if portfolio data is available. After all of the information has been posted, the user clicks on a Submit button, whereby the system confirms the price, the quantity and that all necessary documents concerning the transaction have been read, if any.

The quantity input by a subscriber can be confirmed against the quantities held in an account of that customer and reject the input if greater than the quantity held. This adds a level of assurance to prospective buyers that the seller has the security being offered. In the meantime, the quantity entered is locked up to prevent a subsequent attempt to sell it through another forum.

Referring once again to FIG. 3, the offer is posted on a bid page or the like at the Web site in step 315. In step 320, the interested buyers are preferably automatically notified of the posting by the seller of a security to be auctioned. Buyers that have subscribed with the service browse through the list of securities posted by the sellers. Upon selecting a particular security entry, the server generates a bid screen page for the buyer through which the buyer may enter a bid for that particular security. In the preferred embodiment, the bid page includes a calculator similar to that described above. Bids are received from buyers as indicated at step 325.

After submitting a bid, the system automatically redisplays the Bid screen page so that the buyer may visually observe the ranking during the auction process. The previously entered bid may be edited, for example, to increase the bid price and/or quantity of the security. In response to the buyer selecting on an Edit Bid button, the system redisplays the calculator with the previously entered information automatically displayed therein to be modified by the buyer, as desired. Throughout the entire auction, the buyer while accessing the Bid screen page may adjust the current bid price until the auction ends.

At the end of the auction process the buyer is notified on screen and via email. In step 330, whether or not their bid was accepted. Any conventional medium of communication may be used, for example, e-mail, facsimile, telephone and/or mail. After a successful bid has been accepted by the seller, the type of settlement may be selected from among several options, in step 335. The buyer and seller may exchange information and contact one another to settle the trade privately. Alternatively, or in addition thereto, the parties may elect to settle the purchase through the clearing and settlement system 125. In the latter arrangement, the buyer and seller will receive confirmation notification and follow the rules established by the clearing and settlement system.

The website will also enable users to seek repurchase agreement (“repo”) financing on securities supported by the system. Holders of supported securities who have subscribed to the service may post securities, in an anonymous fashion, on an electronic bulletin board, indicating quantity and desired terms. When posted, any members of the service who are set up to provide financing can browse the bulletin board to determine if there are any securities that they want to finance. Once determined, the financing member selects the security, inputs their proposed financing terms, and sends the information, along with their contact information, to the holder of the security in question. At this point, the holder contacts the financing member and continues the negotiation privately using any conventional method of communication, e.g., e-mail, facsimile, telephone and/or mail.

In a further, optional arrangement, a buyer who desires to purchase a security that is not currently being offered, can post the security, after having selected it from a database of eligible securities made available on an electronic bulletin board, the Internet, or other information source. Once the security has been posted, an automatic notification can be generated to notify any users who own the security of the new opportunity to liquidate or reduce their respective positions. Sellers on the system can then browse through the list of desired securities posted by the buyers. Upon selecting a particular security entry, the server generates an Offer screen page whereby the seller may enter an offer for that particular security, and would go through the same process as described in FIG. 3, steps 300 through 315.

In sum, a consumer can feel confident in purchasing or “repoing” receipts issued by any financial institution irrespective of its trustworthiness or stature because the consumer is always able to confirm that the depositary receipts are backed by the payable instrument.

The preferred embodiment of the present invention provides a method for ensuring that depositary receipts are adequately backed by sufficient collateral, thereby enabling even small and less known financial institutions can act as an issuer of receipts. Digital electronic confirmations of receipt and continued possession of the collateral that underlies a depositary receipt would potentially permit any financial institution to serve as an issuer. This is due, in part, to the trustworthiness imparted to such issuers as a result of continuous real-time monitoring of the presence of such collateral. The system managing such monitoring can enjoy a commission for each payable instrument being monitored.

The present invention is suitable for use with any depositary instrument on which there is a risk of payment default arising from a potential mismatch between the depositary receipt issued and the underlying payable instrument. One embodiment is described in connection with strips created from a bond; however, other derivatives can be created from other collateral. For example, a stream of payables (invoices) can be aggregated into an instrument and components thereof then traded in a marketplace. The risk of default on payment of an invoice is no different in character than the risk that a bond will not be paid.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

We claim:

1. A method for the creation of backed derivatives, comprising the steps of:
(a) depositing a collateral in a clearinghouse firm;
(b) electronically advising a custodian firm of the deposit;
(c) monitoring in real-time for the continued presence of the collateral in the clearinghouse firm; and
(d) authorizing a depository firm to issue a set of derivatives if the continued presence of the collateral is confirmed.

2. The method of claim 1, wherein the monitoring step comprises transferring electronic confirmations between the clearinghouse firm and the custodian firm, the electronic confirmations confirming the continued presence of the collateral in the clearinghouse firm.

3. The method of claim 2, wherein the authorizing step is performed if the electronic confirmations indicate the continued presence of the collateral in the clearinghouse firm.

4. The method of claim 1, including the additional step of charging a commission for each deposited collateral that is being monitored.

5. The method of claim 1, including the additional steps of assigning a security identifier to each derivative in the set of derivative and issuing the set of derivatives for receipt into one or more customer accounts.

6. The method of claim 5, wherein the security identifier is a CUSIP number.

7. The method of claim 5, including the additional steps of continuously polling the clearinghouse firm to confirm the continued presence of the collateral after issuance of the set of derivatives.

8. The method of claim 7, wherein the security identifier is a CUSIP number.

9. The method of claim 1, wherein the collateral is a payable instrument selected from the group of a bond and one or more accounts payable.

10. The method as in claim 9, wherein the collateral is the bond and wherein the set of derivatives comprises a series of strips.

11. The method of claim 1, wherein the collateral is a payable instrument having a first value and wherein the each derivative in the set of derivatives comprises a denomination less than the first value.

12. The method of claim 1, wherein the custodian firm and the depository firm are the same firm.

13. The method of claim 1, wherein the clearinghouse firm electronically advises the custodian firm of the deposit.

14. The method of claim 1, wherein the depository firm prepares the set of derivatives to be issued.

15. A method for the creation of backed derivatives, comprising the steps of:
(e) depositing a collateral having a first value in a clearinghouse firm;
(f) electronically advising a custodian firm of the deposit;
(g) preparing a set of derivatives to be issued, the set of derivatives having a second value that matches the first value;
(h) monitoring in real-time for the continued presence of the collateral in the clearinghouse firm; and
(i) authorizing a depository firm to issue the set of derivatives if the continued presence of the collateral is confirmed.

16. The method of claim 15, wherein the monitoring step comprises transferring electronic confirmations between the clearinghouse firm and the custodian firm, the electronic confirmations confirming the continued presence of the collateral in the clearinghouse firm.

17. The method of claim 16, wherein the authorizing step is performed if the electronic confirmations indicate the continued presence of the collateral in the clearinghouse firm.

18. The method of claim 16, including the additional step of providing the electronic confirmations to an insurance company for monitoring the first value of the collateral.

19. The method of claim 15, including the additional step of charging a commission for each deposited collateral that is being monitored.

20. The method of claim 15, including the additional steps of assigning a security identifier to each derivative in the set of derivative and issuing the set of derivatives for receipt into one or more customer accounts.

21. The method of claim 20, wherein the security identifier is a CUSIP number.

22. The method of claim 20, including the additional steps of continuously polling the clearinghouse firm to confirm the continued presence of the collateral after issuance of the set of derivatives.

23. The method of claim 22, wherein the security identifier is a CUSIP number.

24. The method of claim 15, wherein the collateral is a payable instrument selected from the group of a bond and one or more accounts payable.

25. The method as in claim 24, wherein the collateral is the bond and wherein the set of derivatives comprises a series of strips.

26. The method of claim 15, wherein the collateral is a payable instrument having the first value and wherein the each derivative in the set of derivatives comprises a denomination less than the first value.

27. The method of claim 15, wherein the custodian firm and the depository film are the same firm.

28. The method of claim 15, wherein the clearinghouse firm electronically advises the custodian firm of the deposit.

29. The method of claim 15, wherein the depository firm prepares the set of derivatives to be issued.

30. A computer-implemented method for ensuring that an issuer continues to possess a payable instrument, comprising the steps of:
(j) establishing a communication link between a custodian firm of the issuer and a clearinghouse firm, the clearinghouse firm having a custodial account for the issuer;
(k) polling the clearinghouse firm through the communication link as to whether the issuer possesses the payable instrument in the custodial account;
(l) transferring an electronic confirmation from the clearinghouse firm to the custodian firm across the communication link, the electronic confirmation confirming the presence of the payable instrument in the custodial account of the issuer; and
(m) repeating steps (a) through (c) throughout the trading day.

31. The method of claim 30, including the additional step of providing the electronic confirmation to an insurance company.

32. The method of claim 30, wherein the payable instrument is selected from the group of a bond and one or more accounts payable.

33. The method of claim 30, wherein a set of derivatives is derived from the payable instrument and is issued to customers.

34. The method as in claim 33, wherein the payable instrument is a bond and wherein the set of derivatives comprises a series of strips.
